(19) United States
(12) Patent Application Publication
(10) Pub. No.: US 2007/0146559 A1
(43) Pub. Date: Jun. 28, 2007

(54) Cathode-ray tube type-television device and resin-formed cabinet

(75) Inventor: Yasuo Horiuchi, Osaka (JP)

Correspondence Address: Yokoi & Co., U.S.A., Inc., #723, 13700 Marina Pointe Drive, Marina Del Rey, CA, 90292, US

(73) Assignee: Funai Electric Co., Ltd., Osaka (JP)

(21) Appl. No.: 11/644,252

(22) Filed: Dec. 21, 2006

(30) Foreign Application Priority Data
Dec. 26, 2005 (JP) JP2005-010942 U

(51) Int. Cl. H04N 5/64

(52) U.S. Cl. 348/836

(57) ABSTRACT

The cabinet includes a chassis, a pair of first and second spaced apart guide members provided on the chassis so as to stand vertically from the chassis, and a third guide member provided on a portion of the chassis between the first and second guide members so as to stand vertically from the chassis, the third guide member being formed in a lower portion thereof adjacent the chassis with cutout portions for facilitating removal of the third guide member from the chassis. A first substrate having a first predetermined width is supported to the third guide member and one of the first and second guide members. A second substrate having a second predetermined width larger than the first predetermined width is supported to the first and second guide members, after the removal of the third guide member from the chassis.

### CROSS-REFERENCES TO RELATED APPLICATIONS

The present application is related to the Japanese Utility Model Application No. 2005-010942, filed Dec. 26, 2005, the entire disclosure of which is expressly incorporated by reference herein.

### BACKGROUND OF THE INVENTION

(1) Field of the Invention

The present invention relates to a cathode-ray tube type-television device and a resin-formed cabinet and, more particularly, to a cathode-ray tube type-television device and a resin-formed cabinet, in which substrates different in size from each other are arranged at predetermined positions.

(2) Description of Related Art

A casing body for a television device or the like is generally comprised of a resin-formed cabinet. Electric circuits for the television device are print-wired on a substrate which is arranged within the casing body comprised of the cabinet. Hitherto, in order that the printed circuit board can be arranged in the cabinet, rail members for vertically supporting both side edge portions of the printed circuit board in a width direction of the printed circuit board are provided at predetermined positions of an interior of the casing body. The printed circuit board is inserted at the both side edge portions thereof into the guide members so as to be guided along the guide members, whereby the printed circuit board is arranged at a predetermined position in the casing body.

As well-known, in a television device which is typical of electronic equipment, a plurality of substrates such as printed circuit boards are employed. The substrates are of various sizes according to the applications of the substrates. When a substrate of a different size is required in a cabinet, it is necessary to remodel the cabinet into a new cabinet. Moreover, when it is necessary to cause a substrate having a different function to be recombined with the same cabinet, to thereby produce a product such as a television device having a different function, the cabinet is required to be remodeled into a new cabinet which has the same appearance and in which only a part of the cabinet to which the substrate is mounted is changed.

In order to deal with the employment of substrates having different sizes, there has been proposed a casing body which can allow a substrate having a first predetermined width to be supported by a pair of first guide members and can also allow a substrate having a second predetermined width smaller than the first predetermined width to be supported by one of the first guide members, and a second guide member which is arranged between the first guide members and has a length smaller than the first guide members (see Japanese Utility Model Registration No. 306846 1, for example).

However, such a casing body has the following drawback. That is, even if the second guide member arranged between the first guide members is shorter than the first guide members, in a case where a substrate having a longitudinal length is to be supported by the first guide members, the second guide member becomes a bar to the supporting of the substrate to the first guide members.

Also, there has been known a substrate supporting structure in which a pair of guide members for supporting a substrate in a width direction are provided in a casing body and designed such that tip end portions thereof can expand and contract in order to deal with substrates having different sizes (see Japanese Patent Laid-Open No. H10-190258, for example).

Moreover, there has been known a substrate supporting mechanism in which a pair of guide members for supporting a substrate in a width direction are provided in a casing body and one of the guide members is designed so as to be capable of being moved laterally by a rail in order to deal with substrates having different sizes (see Japanese Patent Laid-Open No. H11-307965, for example).

The above-mentioned two prior art constructions have the following drawback. That is, the constructions make it possible to support substrates having different sizes in the same casing body but it is necessary to newly prepare dies for forming the guide members, since the guide members and the casing body are not formed as a one-piece component.

### BRIEF SUMMARY OF THE INVENTION

The present invention discloses a resin-formed cabinet which can allow substrates different in width from each other to be arranged at predetermined locations and can be integrally formed, and a cathode-ray tube type-television device provided with such a resin-formed cabinet.

One aspect of the present invention provides a cathode-ray tube type-television device comprising: a cathode-ray tube for displaying an image through a face thereof; a speaker for outputting audio; a tuner for receiving television broadcast signals; a first substrate having a first predetermined width; the first substrate having electrical elements for producing an image signal and an audio signal on the basis of the television broadcast signals inputted from the tuner, outputting the image signal to the cathode-ray tube and outputting the audio signal to the speaker; a second substrate having a second predetermined width larger than the first predetermined width; the second substrate having electrical elements like the electrical elements of the first substrate, or having electrical elements for realizing any functions different from functions realized by the electrical elements of the first substrate; a resin-formed cabinet including a front cabinet member having an opening for allowing the face of the cathode-ray tube to be exposed forward therefrom, a chassis provided at a lower portion of an inner surface of the front cabinet member so as to extend rearward, and a back cabinet member combined with the front cabinet member from backward of the front cabinet member; a pair of first and second spaced apart guide members provided on the chassis so as to stand vertically from the chassis; the first guide member and second guide member having a first guide passage and a second guide passage, respectively; the first guide member and the second guide member being arranged on the chassis with the first guide passage and the second guide passage facing each other and being aligned with each other; a third guide member arranged on a portion of the chassis between the first and second guide members so as to vertically stand obliquely from the chassis; the third guide member having a third guide passage and being arranged on the portion of the chassis with the third guide passage facing one of the first and second guide passages of the first and second guide members and being aligned with the one of the first and second guide passages of the first and second guide members; the first substrate being supported to the third guide member and the one of the first and second guide members with both side edge portions thereof being inserted in the third guide passage of the third guide member and the one of the first and second guide passages of the first and second guide members; the third guide member being formed in a portion thereof adjacent the chassis with a plurality of cutout portions for facilitating removal of the third guide member from the chassis; the second substrate being adapted to be supported to the first and second guide members with both side edge portions thereof being inserted in the first and second guide passages, after the removal of the third guide member from the chassis; a first fixture section provided at the lower portion of the inner surface of the front cabinet member for retaining a forward edge portion of the first or second substrate; and a second fixture section provided at a lower portion of an inner surface of the back cabinet member for retaining a rearward edge portion of the first or second substrate.

In the cathode-ray tube type-television device constructed as discussed above, the first, second and third guide members are provided on the chassis of the cabinet and the third guide member arranged between the first and second guide members is formed with the cutout portions for facilitating the removal of the third guide member from the chassis. When it is necessary to cause the second substrate to be supported to the first and second guide members, the third guide member can be easily removed from the chassis, thus making it to possible to cause the second substrate to be easily supported to the first and second guide members. Therefore, according to the present invention, it is possible to provide the cathode-ray tube type-television device which can deal with substrates having various sizes and the general-purpose of which is improved.

Another aspect of the present invention provides a resin-formed cabinet comprising: a front cabinet member; a back cabinet member to be combined with the front cabinet from backward of the front cabinet member; a chassis provided at a lower portion of an inner surface of the front cabinet member so as extend rearward from the front cabinet member; a pair of first and second spaced apart guide members provided on the chassis so as to stand vertically from the chassis for supporting a substrate having a first predetermined width; and a third guide member provided on a portion of the chassis between the first and second guide member so as to vertically stand from the chassis for supporting a substrate having a second predetermined width in cooperation with one of the first and second guide members; the first predetermined width being larger than the second predetermined width; and the third guide member being formed in a portion thereof adjacent the chassis with a plurality of cutout portions for facilitating removal of the third guide member from the chassis.

The resin-formed cabinet constructed as discussed above is suitable particularly as a cabinet for an electrical appliance.

An optional aspect of the present invention provides a resin-formed cabinet, wherein the first guide member and the second guide member have a first guide passage and a second guide passage, the first guide member and the second guide member are arranged on the chassis with the first guide passage and the second guide passage facing each other, and being aligned with each other and parallel to the chassis, and the third guide member has a third guide passage and is arranged on the portion of the chassis with the third guide passage facing the guide passage of the one of the first and second guide members and being aligned with the guide passage of the one of the first and second guide members and parallel to the chassis.

The resin-formed cabinet constructed as discussed above is simple in construction and can various substrates.

Another optional aspect of the present invention provides a resin-formed cabinet, wherein the third guide member vertically stands obliquely from the chassis.

The resin-formed cabinet constructed as discussed above makes it possible to further facilitate the removal of the third guide member from the chassis.

Another optional aspect of the present invention provides a resin-formed cabinet, wherein the front cabinet member is provided at the lower portion of the inner surface thereof with a first fixture section for retaining a forward edge portion of the substrate having the first predetermined width or a forward edge portion of the substrate having the second predetermined width, and the back cabinet member is provided at a lower portion of an inner surface thereof with a second fixture section for retaining a rearward edge portion of the substrate having the first predetermined width or a rearward edge portion of the substrate having the second predetermined width.

The resin-formed cabinet constructed as discussed above makes it possible to cause substrates having various sizes to be securely supported at predetermined locations, thus improving the general-purpose of the resin-formed cabinet.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary illustration of a schematic perspective view showing an appearance of a front cabinet member;

FIG. 2 is an exemplary illustration of a schematic enlarged perspective view of a part of a first guide member;

FIG. 3 is an exemplary illustration of a schematic enlarged perspective view of a part of a third guide member;

FIG. 4 is an exemplary illustration of a schematic plan view of the front cabinet member which is of assistance in explaining a condition where a first substrate having a width W2 is supported to a second guide member and the third guide member;

FIG. 5 is an exemplary illustration of a schematic fragmentary rear view of the front cabinet member which is of assistance in explaining the condition where the first substrate is supported to the second guide member and the third guide member;

FIG. 6 is an exemplary illustration of a schematic plan view of the front cabinet member which is of assistance in explaining a condition where a second substrate having a width W1 is supported to the first guide member and the second guide member;

FIG. 7 is an exemplary illustration of a schematic fragmentary rear view of the front cabinet member which is of assistance in explaining the condition where the second substrate is supported to the first guide member and the second guide member;

FIG. 8 is an exemplary illustration of a schematic sectional view of a modification of the third guide member shown in FIG. 3;

FIG. 9 is an exemplary illustration of a schematic perspective view of a front cabinet member provided with a first fixture section;

FIG. 10 is an exemplary illustration of a schematic perspective view of a back cabinet member provided with a second fixture section;

FIG. 11 is an exemplary illustration of a schematic partially sectional view which is of assistance in explaining the second substrate arranged at a predetermined location in a cabinet comprised of the front cabinet member of FIG. 9 and the back cabinet member of FIG. 10;

FIG. 12 is an exemplary illustration of a schematic exploded perspective view of a cathode-ray tube type-television device according to an embodiment of the present invention; and

FIG. 13 is an exemplary illustration of a block diagram of electrical elements mounted on the first substrate.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

A cathode-ray tube type-television device according to an embodiment of the present invention will be discussed in the following order:

(1) Explanation of a cathode-ray tube type-television device;

(2) Structure of a chassis employed in the cathode-ray tube type-television device;

(3) Process for arranging substrates;

(4) Modified Example; and

(5) Summary.

(1) Explanation of a Cathode-Ray Tube Type-Television Device:

FIG. 12 is a schematic exploded perspective view of a cathode-ray tube type-television device 10 according to the embodiment of the present invention. The cathode-ray tube type-television device 10 includes a casing body 1 or a cabinet, a cathode-ray tube 2, a first substrate 3A and a speaker 4. In the illustrated example, the cathode-ray tube type-television device 10 is designed so as to receive television broadcast signals and then broadcast predetermined television programs through the cathode-ray tune 2.

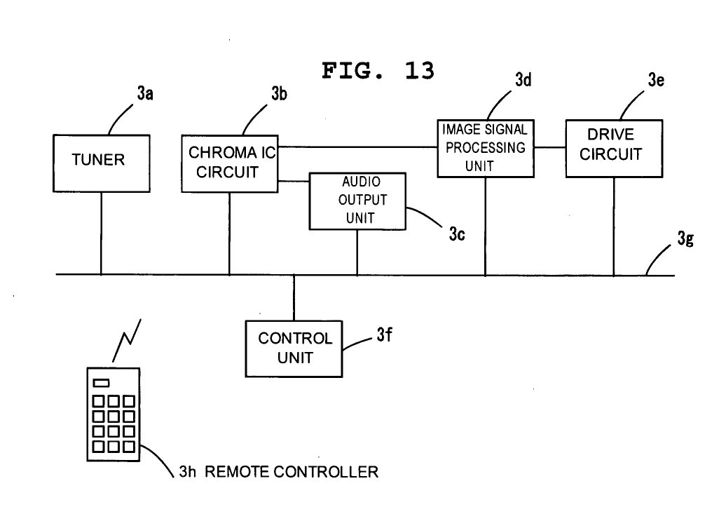

The substrate 3A is designed so as to produce an image signal and an audio signal on the basis of the television signals inputted from a tuner, output the image signal to the cathode-ray tube and also output the audio signal to the speaker. FIG. 13 is a block diagram exhibiting the substrate which is employed in the embodiment of the present invention. In the illustrated example, the substrate 3A is provided with the tuner 3a, a chroma IC circuit 3b, an audio output unit 3c, an image processing unit 3d, a drive circuit 3e, and a control unit 3f.

In the illustrated example, the component elements provided on the substrate are connected to one another through an IIC bus 3g and the control unit 3f is adapted to control the entire substrate. For example, when a user operates a remote controller 3h whereby instructions are given to the cathode-ray tube type-television device, the instructions are once sent to the control unit 3f from which the instructions are transmitted to the respective component elements which carry out predetermined processes according to the instructions. Moreover, the control unit 3f has execution programs stored therein, which are to be used when the image signal and the audio signal are subjected to signal processing. The control unit 3f is designed so as to start the execution programs according to the instructions from the user, to thereby direct the respective component elements to execute the signal processing.

The tuner 3a is designed so as to detect a television broadcast signal which corresponds to a predetermined program which the user selects from the television broadcast signals received through an unshown antenna, by operating the remote controller 3h or the like, and then output the television broadcast signal to the chroma IC circuit 3b.

The chroma IC circuit 3b is designed so as to demodulate the image signal and the audio signal from the television broadcast signal which is outputted from the tuner 3a and corresponds to the predetermined program, and output the image signal and the audio signal to the image signal processing unit 3d and the audio output unit 3c, respectively.

The image signal processing unit 3d is designed so as to cause the inputted image signal to be subjected to analog-digital conversion, and also produce image signals which correspond to the colors R, G and B. Then, the image signal processing unit 3d causes the image signals to be subjected to image processing such as gamma correction and, thereafter, outputs to the drive circuit 3e the image signals which have been subjected to the signal processing.

The drive circuit 3e receives the respective image-processed image signals corresponding to the colors R, G and B, and then produces a drive voltage for making predetermined pixels of the cathode-ray tube.

The audio output unit 3c receives the audio signal outputted from the chroma IC circuit 3b, amplitudes the audio signal on the basis of the command which the user gives by operating the remote controller or the like and, thereafter, outputs the audio signal to the speaker 4. The speaker 4 converts the audio signal into air vibration, whereby audio is outputted.

The cathode-ray tube 2 comprises a glass tube having a face for displaying an image and a fluorescent surface formed by applying fluorescent substances of colors R, G and B onto an inner surface of the face, and an electron gun for emitting electron beams onto the fluorescent surface. The electron gun emits the electron beams onto predetermined positions of the fluorescent surface on the basis of the drive voltage outputted from the drive circuit 3e. The electron beams are struck against the fluorescent surface formed by applying the fluorescent substrate of colors R, G and B onto the inner surface of the face, whereby the fluorescent substrates are brightened. The light emissions from the fluorescent substances are combined with one another, whereby the cathode-ray tube 2 displays a predetermined image.

The casing body 1 is comprised of a front cabinet member 5 and a back cabinet member 6 which are formed of resin. Now, a process for causing the cathode-ray tube 2, the speaker 4, and the substrate 3A stored within the casing body 1 will be discussed. First, the cathode-ray tube 2 and the speaker 4 are screw-fastened to the front cabinet member 5 and, then, the substrate 3A is fixed to a chassis 7. Thereafter, the front cabinet member 5 and the back cabinet member 6 are screw-fastened to each other. By this process, the cathode-ray tube 2, the speaker 4 and the substrate 3A are arranged at predetermined positions in the casing body 1.

(2) Structure of the Chassis Employed in the Cathode-Ray Tube Type-Television Device:

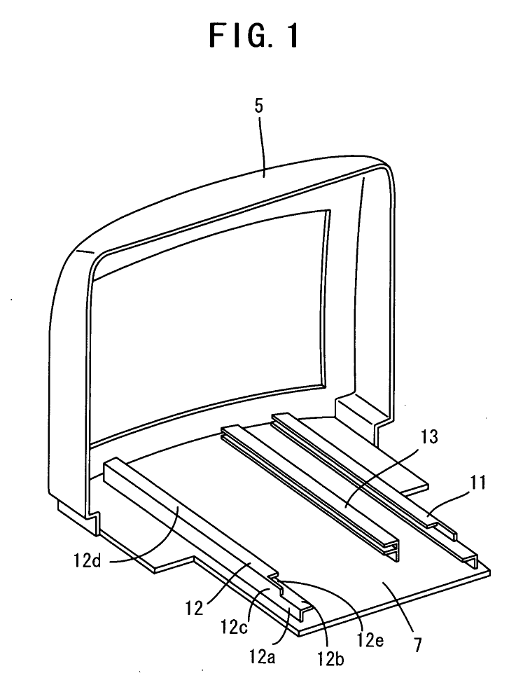

FIG. 1 is a schematic perspective view illustrating an appearance of the front cabinet member for the television device according to the embodiment of the present invention. In the illustrated example, the front cabinet member 5 has an opening for allowing the face of the cathode-ray tube 2 secured to the casing body 1 to be exposed forward from the casing body 1. Moreover, the chassis 7 with which the substrate 3A having the various circuits for realizing various functions of the television device mounted thereon is to be combined, is provided at a lower portion of the front cabinet member 5 so as to extend rearward from an inner surface of the front cabinet member 5.

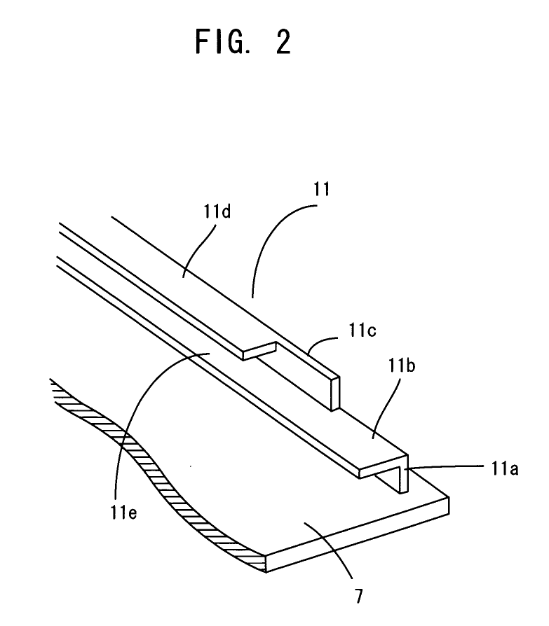

The chassis 7 is provided with a pair of a first guide member 11 and a second guide member 12, and a third guide member 13. The first guide member 11 and the second guide member 12 are provided on opposite edge portions of the chassis 7. The third guide member 13 is provided on a portion of the chassis 7 between the first and second guide members 11, 12. FIG. 2 is a schematic enlarged perspective view of a part of the first guide member 11. The first guide member 11 comprises a first vertical section 11a standing vertically from the chassis 7 and extending along an edge portion of the chassis 7, a first rail 11b extending along a total length of an upper edge of the first vertical section 11a and projecting inward from the first vertical section 11a substantially parallel with the chassis 7, a second vertical section 11c standing vertically from an outer edge of the first rail 11b and extending forward along a region of the outer edge of the first rail 11b except a rearward region of the outer edge of the first rail 11b, a second rail 11d extending forward along a region of an upper edge of the second vertical section 11c except a rearward region of the upper edge of the second vertical section 11c and projecting inward from the second vertical section 11c substantially parallel with the chassis 7, and a guide passage 11e which is formed by the first rail 11b, the second vertical section 11c and the second rail 11d.

The second guide member 12 is provided on an edge portion of the chassis 7 which is opposite to the edge portion of the chassis 7 on which the first guide member 11 is arranged. The second guide member 12 is constructed in the same manner as the first guide member 11 is done. More particularly, as shown in FIG. 1, the second guide member 12 comprises a first vertical section 12a standing vertically from the chassis 7 and extending along an edge portion of the chassis 7, a first rail 12b extending along a total length of an upper edge of the first vertical section 1 2a and projecting inward from the first vertical section 11a substantially parallel with the chassis 7, a second vertical section 12c standing vertically from an outer edge of the first rail 12b and extending forward along a region of the outer edge of the first rail 12b except a rearward region of the outer edge of the first rail 12b, a second rail 12d extending forward along a region of an upper edge of the second vertical section 12c except a rearward region of the upper edge of the second vertical section 12c and projecting inward from the second vertical section 12c substantially parallel with the chassis 7, and a second rail 12e which is formed by the first rail 12b, the second vertical section 12c and the second rail 12d.

The first and second guide members 11, 12 are arranged on the chassis 7 in such a manner that the guide passage 11e of the first guide member 11 and the guide passage 12e of the second guide member 12 face each other and are aligned with each other and parallel to the chassis 7.

The first guide member 11 and the second guide member 12 are spaced apart from each other by a distance slightly larger than a width of a second substrate to be supported to the first and second guide members 11, 12. Heights of the guide passages 11e, 12e of the first and second guide members 11, 12 are same and slightly larger than a thickness of the second substrate to be supported to the first and second guide members 11, 12. The second substrate may have component elements like the component elements of the first substrate 3A, or may have component elements for realizing any suitable functions different from the functions which are realized by the component elements of the first substrate 3A.

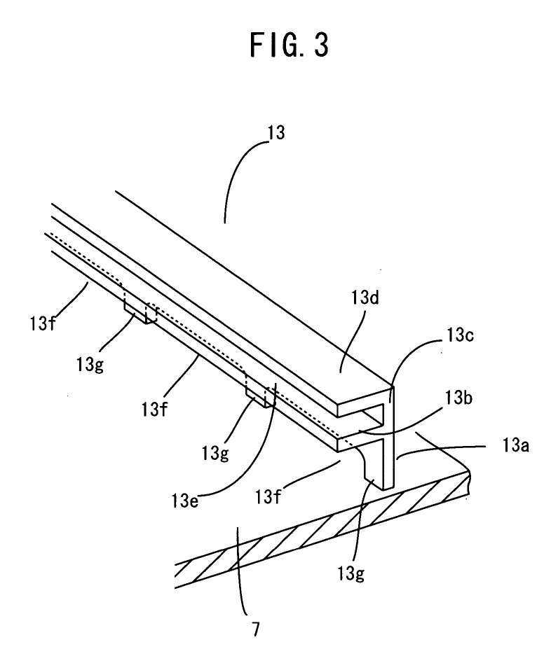

FIG. 3 is a schematic enlarged perspective view of the third guide member 13. The third guide member 13 is constructed in a substantially same manner as the first and second guide members 11, 12 are done, except that the third guide member 13 includes a plurality of cutout portions and a plurality of leg portions. More particularly, the third guide member 13 comprises a first vertical section 13a standing vertically from the chassis 7 and extending in parallel with the first vertical sections 11a, 12a of the first and second guide members 11, 12, a first rail 13b extending along a total length of an upper edge of the first vertical section 13a and projecting from the first vertical section 13a substantially parallel with the chassis 7, a second vertical section 13c standing vertically from an outer edge of the first rail 13b and extending forward along a total length of the outer edge of the first rail 13b, a second rail 13d extending forward along a total length of an upper edge of the second vertical section 13c and projecting inward from the second vertical section 13c substantially parallel with the chassis 7, and a guide passage 13e which is formed by the first rail 13b, the second vertical section 13c, and the second rail 13d. The third guide member 13 is arranged adjacent the first guide member 11 in such a manner that the guide passage 13e thereof faces the guide passage 12e of the second guide member 12 and is aligned with the guide passage 12e of the second guide member 12 and parallel to the chassis 7. A height of the guide passage 13e of the third guide member 13 corresponds to that of the guide passage 12e of the second guide member 12. The first substrate is adapted to be supported to the second and third guide members 12, 13. Therefore, the height of the guide passage 13e of the third guide member 13 is slightly larger than a thickness of the first substrate and the third guide member 13 is spaced apart from the second guide member 12 by a distance slightly larger than the width of the first substrate.

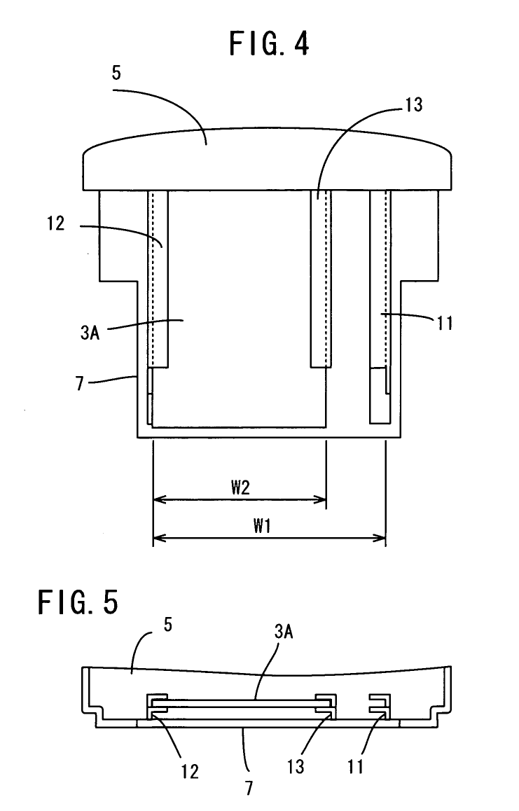

Referring now to FIGS. 4 and 5, the first substrate 3A which has a width W2 smaller than W1 of the second substrate to be supported to the first and second guide members 11, 12, can be supported to the second guide member 12 and the third guide member 13 by inserting both edges of the first substrate 3A into the guide passages 12e, 13e of the second guide and third guide members 12, 13.

When the second substrate having the width W1 is to be supported to the first and second guide members 11, 12 by inserting both edge portions of the first substrate into the guide passages of the first and second guide members 11, 12, the insertion of the both edge portions of the second substrate is interrupted by the third guide member 13 arranged between the first and second guide members 11, 12. In order to avoid this problem, the third guide member 13 is designed so as to be easily removed from the chassis 7 when the second substrate is to be supported to the first and second guide members 11, 12.

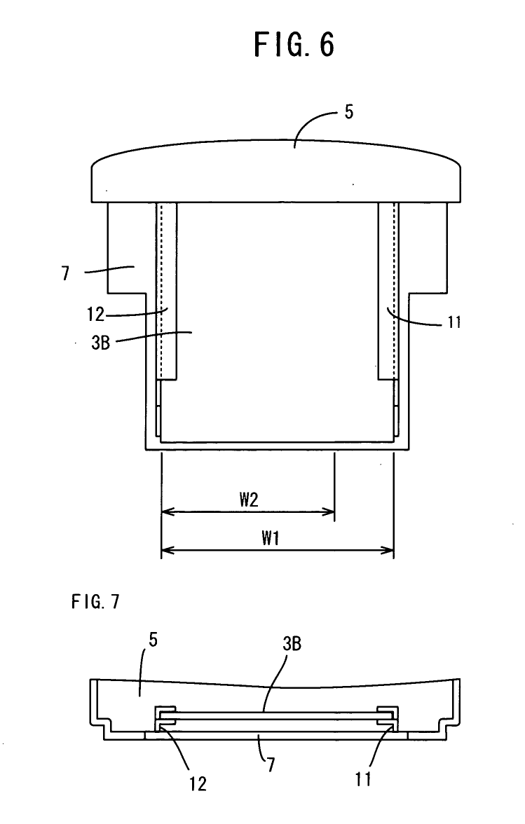

Again referring to FIG. 3, the first vertical section 13a of the third guide member 13 has cutout portions 13f and leg portions 13g which are formed by cutting predetermined regions of a lower longitudinal portion of the first vertical section 13a of the third guide member 13 out and are alternately disposed along the lower longitudinal portion of the first vertical section 13a. In the illustrated example, the third guide member 13 is connected to the chassis 7 at the leg portions 13g only. In the third guide member 13 constructed as discussed above, when the third guide member 13 is to be removed from the chassis 7 in order that the second substrate can be supported to the first and second guide members 11, 12, the removal of the third guide member 13 from the chassis 7 can be carried out by cutting the leg portions 13g away from the chassis 7 utilizing a tool such as a nipper, or with worker's fingers. Thus, the second substrate 3B having the width W1 larger than W2 of the first substrate can be supported to the first and second guide members 11, 12 by inserting the both edge portions of the second substrate 3B as shown in FIGS. 6 and 7.

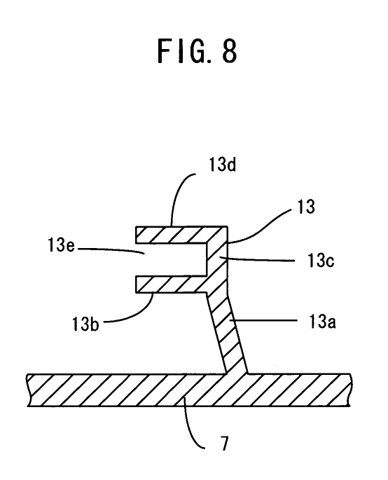

Referring to FIG. 8, the third guide member 13 may be designed in such a manner that the first vertical section 13a of the third guide member 13 stands obliquely from the chassis 7, and the first and second rails 13b, 13d of the third guide member 13 are parallel to the chassis 7. In this case, it is possible to easily insert the tool such as the nipper into a spaced under the first rail 13b of the third guide member 13, thus making it possible to easily cut the third guide member 13 away from the chassis 7. Incidentally, while the construction of the third guide member 13 is not limited to the constructions shown in FIGS. 3 and 8, any other suitable construction for the third guide member 13 can be employed as far as the construction facilitates the removal of the third guide member 13 from the chassis 7 by the nipper or the like, or with the worker's fingers.

(3) Process for Arranging the Substrates:

Again referring to FIGS. 4 and 5, a process for arranging the first substrate 3A having the width W2 smaller than W1 of the second substrate will be discussed in greater detail hereinafter. As discussed above, the second guide member 12 and the third guide member 13 are spaced apart from each other by the distance slightly larger than the width W2 of the first substrate 3A, and the guide passage of the second guide member 12 and the guide passage of the third guide member 13 are aligned with each other. Moreover, the heights of the guide passages of the second and third guide members 12, 13 are slightly larger than the thickness of the first substrates 3A. Therefore, the both edge portions of the first substrate 3A can be easily inserted into the guide passages of the second and third guide members 12, 13, while being guided toward the front cabinet member 5 along the guide passages of the second and third guide members 12, 13, whereby the first substrate 3A is supported to the second and third guide members 12, 13 as shown in FIGS. 4 and 5.

Again referring to FIGS. 6 and 7, a process for arranging the second substrates 3B having the width W1 larger than W2 of the first substrate will be discussed in greater detail hereinafter. As discussed above, the first guide member 11 and the second guide member 12 are spaced apart from each other by the distance slightly larger than the width W1 of the second substrate 3B, the guide passages of the first and second guide members 11, 12 are aligned with each other. Moreover, the heights of the guide passages of the first and second guide members 11, 12 are slightly larger than the thickness of the second substrate 3B. Therefore, the both edge portions of the second substrate 3B can be easily inserted into the guide passages of the first and second guide members 11, 12 while being guided toward the front cabinet member 5 along the guide passages of the first and second guide members 11, 12, whereby the second substrate 3B is supported to the first and second guide members 12, 13 as shown in FIGS. 6 and 7. Of course, when the second substrate 3B is to be supported to the first and second guide members 11, 12, the third guide member 13 is removed from the chassis 7.

(4) Modified Example:

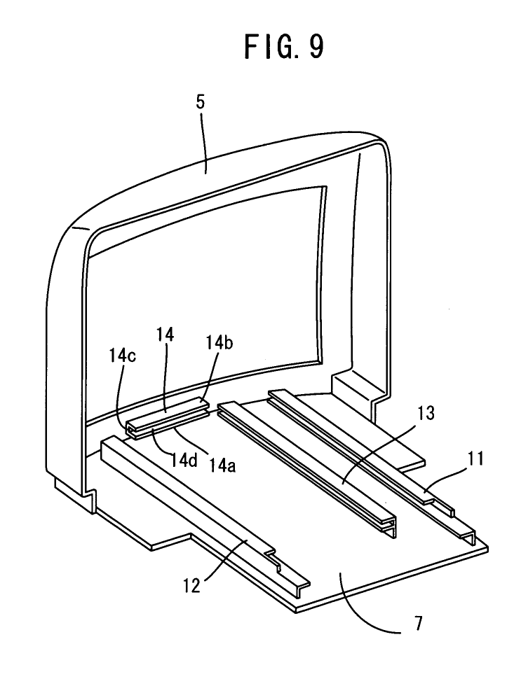

Referring to FIGS. 9 to 11, a modified example of the embodiment shown in FIGS. 1 to 8 will be discussed hereinafter. The modified example is constructed in a substantially same manner as the embodiment of FIGS. 1 to 8 except that the modified example comprises a first fixture section 14 provided at the front cabinet member 5 for retaining a forward edge portion of the substrate 3A or 3B, and a second fixture section 15 provided at the back cabinet member 6 for retaining a rearward edge portion of the substrate 3A or 3B.

As shown in FIG. 9, the first fixture section 14 is provided on an inner surface of a portion of the front cabinet member 5 which is lower than the opening of the front cabinet member 5 and spaced apart from the chassis 7 by a predetermined distance. The first fixture section 14 is projected rearward from the front cabinet member 5 by a predetermined distance, and formed into a substantially U-shape in cross-section. More particularly, the first fixture section 14 comprises a pair of vertically spaced apart horizontal-sections 14a, 14b and an intermediate section 14c interconnecting the horizontal-sections 14a, 14b. The first fixture section 14 is provided on the inner surface of the front cabinet member 5 with an opening 14d of the substantially U-shaped fixture section 14 facing rearward and being aligned with a plane corresponding to the guide passages of the first, second and third guide members 11, 12, 13. The opening 14d of the first fixture section 14 has a height corresponding to those of the guide passages of the first, second and third guide members 11, 12, 13.

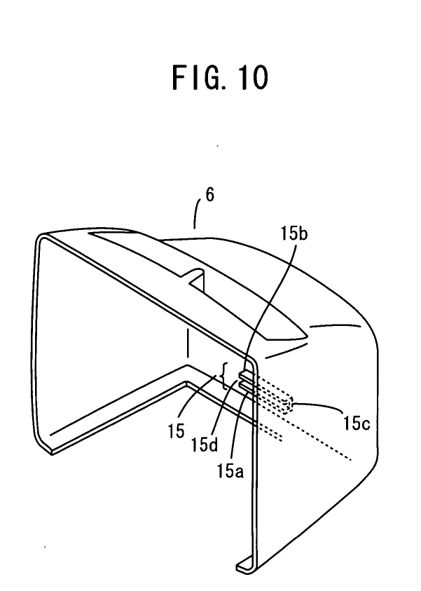

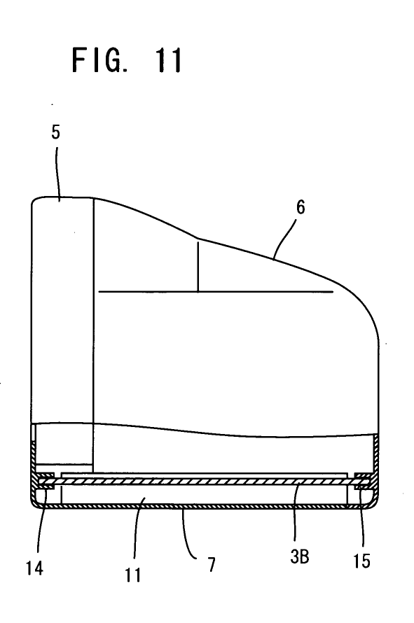

As shown in FIG. 10, the second fixture section 15 is provided on an inner surface of a lower portion of the back cabinet member 6 so as to project forward from the back cabinet member 6 by a predetermined distance, and formed into a substantially U-shape in cross-section. More particularly, the second fixture section 15 comprises a pair of vertically spaced apart horizontal-sections 15a, 15b and an intermediate section 15c interconnecting the horizontal-sections 15a, 15b. The second fixture section 15 is provided on the inner surface of the back cabinet member 6 with an opening 15d of the substantially U-shaped fixture section 15 facing forward, being aligned with the plane corresponding to the guide passages of the first, second and third guide members 11, 12, 13 and being aligned with the opening 14d of the first fixture section 14 The opening 15d of the second fixture section 15 has a height corresponding to those of the opening 14d of the first fixture section 14 and the guide passages of the first, second and third guide members 11, 12 13.

In the modified example constructed as discussed above, a distance between the opening 14d of the first fixture section 14 and the opening 15d of the second fixture section 15 is set to a length substantially equal to a length of each of the substrates when the front cabinet member 5 and the back cabinet member 6 are screw-fastened to each other. Moreover, the heights of the openings 14d, 15d of the first and second fixture sections 14, 15 are slightly larger than the thickness of each of the substrates.

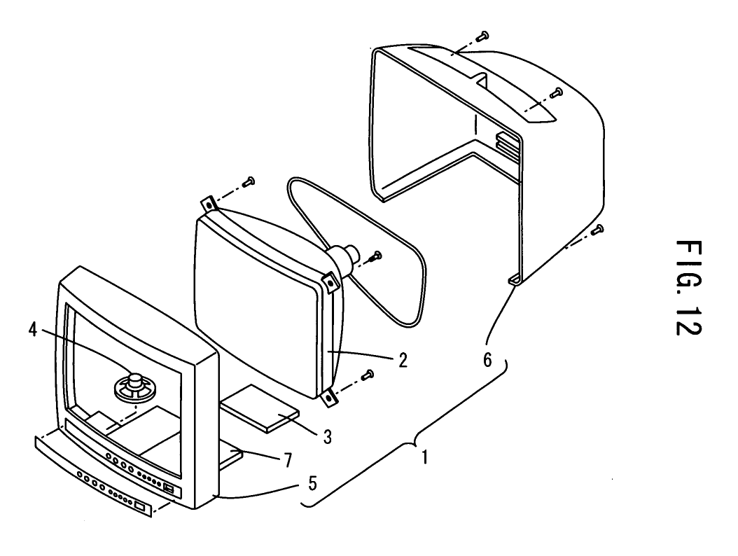

Since the first substrate 3A having the width W2 is arranged at a predetermined location in the modified example in the same manner as the second substrate 3B is arranged at a predetermined location, only a process for causing the second substrate 3B to be arranged at the predetermined location in the modified example will be discussed hereinafter with reference to FIG. 11. When the second substrate 3B is to be arranged at the predetermined location, first of all, the third guide member is removed from the chassis 7. After the both edge portions of the second substrate 3B in the width direction thereof are supported to the first and second guide members 11, 12 (only first guide member 11 is shown in FIG. 11), the forward edge portion of the second substrate 3B is inserted into the opening 14d of the first fixture section 14 provided at the front cabinet member 5. At this time, the both edge portion of the second substrate 3B are supported by the first and second guide members 11, 12, so that when the second substrate 3B is pushed toward the front cabinet member 5, the forward edge portion of the second substrate 3B can be easily inserted into the opening 14d of the first fixture section 14.

Successively, the front cabinet member 5 and the back cabinet member 6 are screw-fastened to each other. At this time, the second substrate 3B is supported at the both side edge portions thereof to the first and second guide members 11, 12 and supported at the forward edge portion thereof to the first fixture section 14 as discussed above, namely, the second substrate 3B is supported at the three edge portions thereof including the both side edge portions and the forward edge portions. Moreover, as discussed above, the distance between the opening of the first fixture section 14 and the opening of the second fixture 15 is set to the length substantially equal to the length of the substrate when the front cabinet member 5 and the back cabinet member 6 are screw-fastened to each other. Therefore, when the front cabinet member 5 is screw-fastened to the back cabinet member 6, the rearward edge portion of the second substrate 3B can be securely inserted into the opening 15d of the second fixture section 15. Thus, the second substrate 3B is supported at the both side edge portions thereof to the first and second guide members 11, 12 and supported at the forward and rearward edge portions thereof to the first and second fixture sections 14, 15, whereby the second substrate 3B can be arranged at the predetermined location.

(5) Summary:

As discussed above, the resin-formed cabinet according to the present invention includes the chassis, a pair of the first and second guide members standing vertically from the chassis for supporting the second substrate of the predetermined width so as to hold the second substrate from the both side edge portions of the second substrate, and the third guide member arranged between the first and second guide members and standing vertically from the chassis for supporting the first substrate of the width smaller than that of the second substrate in cooperation with one of the first and second guide member so as to hold the first substrate from the both side edge portions of the first substrate, the third guide member being formed in the lower portion thereof with the predetermined number of the cutout portions for facilitating the removal of the third guide member from the chassis, the third guide member being adapted to be removed from the chassis when the second substrate is to be supported to the first and second guide members.

Incidentally, in the above-mentioned embodiments, the first and second substrates which the same thickness are employed. In a case where a first substrate and a second substrate which are different from each other in thickness are employed, a height of each of the guide passages of the first, second and third guide members and the openings of the first and second fixture sections may be designed so as to be slightly larger than a thickness of one of the first and second substrates, namely, a thickness of the one substrate having a larger thickness. Moreover, while the third guide member is arranged on the chassis with the guide passage thereof facing the guide passage of the second guide member in the illustrated examples, the third guide member may be arranged on the chassis with the guide passage thereof facing the guide passage of the first guide member.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object. In addition, reference to “first,” “second,” “third,” and etc. members throughout the disclosure (and in particular, claims) is not used to show a serial or numerical limitation but instead is used to distinguish or identify the various members of the group.

What is claimed is:

1. A cathode-ray tube type-television device comprising:
a cathode-ray tube for displaying an image through a face thereof;
a speaker for outputting audio;
a tuner for receiving television broadcast signals;
a substrate having a predetermined width;
the substrate having electrical elements for producing an image signal and an audio signal on the basis of the television broadcast signals inputted from the tuner, outputting the image signal to the cathode-ray tube and outputting the audio signal to the speaker;
a resin-formed cabinet including a front cabinet member having an opening for allowing the face of the cathode-ray tube to be exposed forward therefrom, a chassis provided at a lower portion of an inner surface of the front cabinet member for extending rearward, and a back cabinet member combined with the front cabinet member from backward of the front cabinet member;
a pair of first and second spaced apart guide members provided on the chassis so as to stand vertically from the chassis;
the first guide member and second guide member having a first guide passage and a second guide passage, respectively;
the first guide member and the second guide member arranged on the chassis with the respective first guide passage and the second guide passage facing each other and aligned with each other;
a third guide member arranged on a portion of the chassis between the first and second guide members for vertically standing obliquely from the chassis;
the third guide member having a third guide passage and arranged on the portion of the chassis with the third guide passage facing one of the first and second guide passages of the respective first and second guide members and aligned with the one of the first and second guide passages of the first and second guide members;
the third guide member formed in a portion thereof adjacent the chassis with a plurality of cutout portions for facilitating removal of the third guide member from the chassis;
a first fixture section provided at the lower portion of the inner surface of the front cabinet member for retaining a forward edge portion of the first or second substrate; and
a second fixture section provided at a lower portion of an inner surface of the back cabinet member for retaining a rearward edge portion of the first or second substrate.

2. A resin-formed cabinet comprising:
a front cabinet member;
a back cabinet member to be combined with the front cabinet from backward of the front cabinet member;
a chassis provided at a lower portion of an inner surface of the front cabinet member, extending rearward from the front cabinet member;
a pair of first and second spaced apart guide members provided on the chassis for standing vertically from the chassis for supporting a substrate having a first predetermined width; and
a third guide member provided on a portion of the chassis between the first and second guide member for vertically standing from the chassis for supporting a substrate having a second predetermined width in cooperation with one of the first and second guide members;
the first predetermined width being larger than the second predetermined width; and
the third guide member being formed in a portion thereof adjacent the chassis with a plurality of cutout portions for facilitating removal of the third guide member from the chassis.

3. A resin-formed cabinet according to claim 2, wherein the first guide member and the second guide member have a first guide passage and a second guide passage, the first guide member and the second guide member are arranged on the chassis with the first guide passage and the second guide passage facing each other, and being aligned with each other and parallel to the chassis, and the third guide member has a third guide passage and is arranged on the portion of the chassis with the third guide passage facing the guide passage of the one of the first and second guide members and being aligned with the guide passage of the one of the first and second guide members and parallel to the chassis.

4. A resin-formed cabinet according to claim 2, wherein the third guide member vertically stands obliquely from the chassis.

5. A resin-formed cabinet according to claim 2, wherein the front cabinet member is provided at the lower portion of the inner surface thereof with a first fixture section for retaining a forward edge portion of the substrate having the first predetermined width or a forward edge portion of the substrate having the second predetermined width, and the back cabinet member is provided at a lower portion of an inner surface thereof with a second fixture section for retaining a rearward edge portion of the substrate having the first predetermined width or a rearward edge portion of the substrate having the second predetermined width.
